(19) United States
(12) Patent Application Publication
(10) Pub. No.: US 2019/0133887 A1
(43) Pub. Date: May 9, 2019

(54) MEDICATION DISPENSER WITH ALARM

(71) Applicant: MARK VAUGHAN, Winston-Salem, NC (US)

(72) Inventor: MARK VAUGHAN, Winston-Salem, NC (US)

(21) Appl. No.: 15/622,112

(22) Filed: Jun. 14, 2017

(51) Int. Cl. A61J 7/04; A61J 1/03

(52) U.S. Cl. CPC A61J 7/0427; A61J 7/0472; A61J 1/03

(57) ABSTRACT

The Rx Secure medication dispenser is the only product of its kind that features an integrated alarm system which will automatically emit an audible sound along with flashing lights in attempt to notify the user of medication that needs to be taken; any attempts to tamper with or open the device will result in an alert that will be provided to their doctor or caregiver immediately. The Rx Secure is uniquely designed to be manufactured with Plexiglas and metal materials for maximum durability and is intended to be available with a battery back-up as an added safeguard to provide optimal security and to prevent abuse.

### BACKGROUND OF THE INVENTION

### Field of the Invention

The present invention is a medical device. More specifically, the present invention is a medication dispenser with alarm.

### Description of the Related Art

There are currently no feasible products on the market that offer an effective way to limit the distribution of pills to a patient. Prescription drugs are easily attainable allowing misuse to become increasingly widespread; due to insufficient monitoring and regulation of distribution, drug abuse can cause physical and emotional pain for abusers as well as their families. The standard plastic bottles given to the patient, can be used at their discretion regardless of the doctor's instructions.

### SUMMARY OF THE INVENTION

The present invention is a personalized electronic prescription pill dispenser that distributes medications as directed by a licensed physician/doctor.

The medication dispenser includes up to five channels, a metal tray, an alarm with lights, and a plug.

It is an object of the present invention to provide consumers with a medication dispenser in which medication is loaded and programmed by a pharmacist or doctor, and then a call center is notified to monitor the device.

It is an object of the present invention to provide a medication dispenser that releases precise doses of medication on specific dates and times to ensure proper adherence of prescribed medicine.

It is an object of the present invention to provide an integrated alarm system which will automatically emit an audible sound along with flashing lights in an attempt to notify the user of medication that needs to be taken.

It is an object of the present invention to provide an alert that will be provided to the doctor or caregiver immediately if there are any attempts to tamper with or open the device.

It is an object of the present invention to provide a medication dispenser that is manufactured with plexiglass and metal materials for maximum durability.

It is an object of the present invention to provide a medication dispenser with a battery back-up as an added safeguard to provide optimal security and to prevent abuse.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front view of a medication dispenser with alarm, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

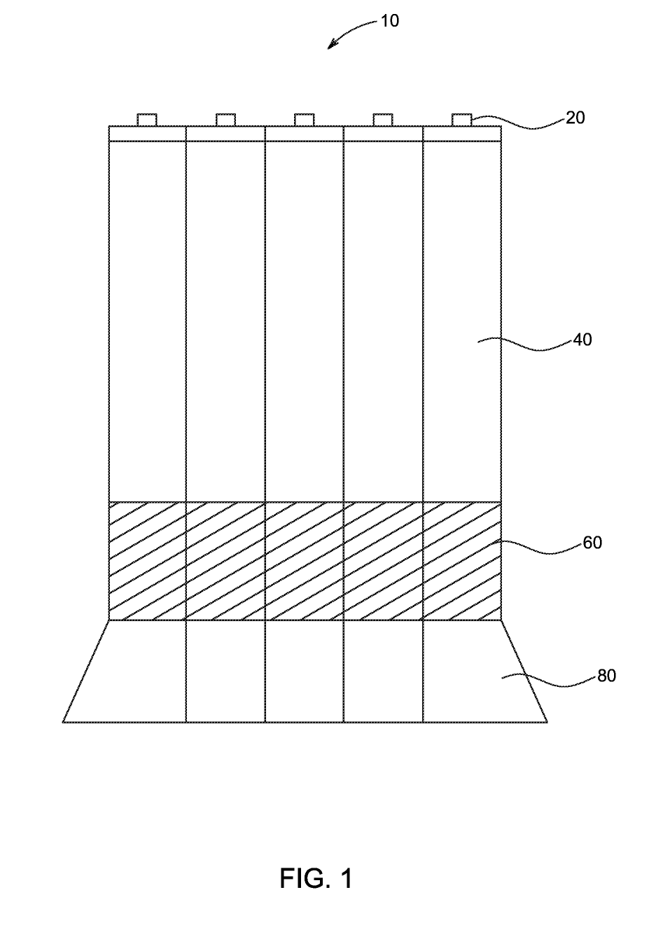

Referring now to FIG. 1, illustrated is a front view of the medication dispenser with alarm 10, in accordance with one embodiment of the present invention.

In FIG. 1, illustrated is a front view of the medication dispenser with alarm 10, including a dispense alert light 20, which automatically emits an audible sound along with flashing lights in an attempt to notify the user of medication that needs to be taken. A body made of clear Plexiglas 40, making the medication visible to the patient, is provided along with a mechanical dispensing device 60, and a metal tray 80.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

1. A medication dispensing device, said device comprising:
a housing;
said housing having channels therein;
an alarm disposed on a top edge of each channel; and
a tray.

2. The medication dispensing device according to claim 1, wherein said channels comprises up to five channels.

3. The medication dispensing device according to claim 1, wherein said alarm includes flashing lights to notify the user of medication that needs to be taken.

4. The medication dispensing device according to claim 1, wherein said tray is a made of a material such as metal.

5. The medication dispensing device according to claim 2, wherein said channels dispense the medication into the tray.

6. The medication device according to claim 1, wherein said device releases precise doses of medication on specific dates and times to ensure proper adherence of prescribed medicine.

7. The medication device according to claim 1, wherein said device allows for medication to be loaded and programmed by a pharmacist or doctor.

8. The medication dispensing device according to claim 3, wherein said alarm will automatically emit an audible sound to notify the user of medication that needs to be taken.
